(19) United States
(12) Patent Application Publication
(10) Pub. No.: US 2026/0088492 A1
(43) Pub. Date: Mar. 26, 2026

(54) ELECTRONIC DEVICE

(71) Applicant: Advanced Semiconductor Engineering, Inc., Kaohsiung (TW)

(72) Inventors: Shao-En HSU, Kaohsiung (TW); Huei-Shyong CHO, Kaohsiung (TW)

(73) Assignee: Advanced Semiconductor Engineering, Inc., Kaohsiung (TW)

(21) Appl. No.: 18/898,647

(22) Filed: Sep. 26, 2024

(51) Int. Cl. H01Q 3/24; H01Q 1/22; H01Q 13/06

(52) U.S. Cl. CPC H01Q 3/24; H01Q 1/22; H01Q 13/06

(57) ABSTRACT

The present disclosure provides an electronic device. The electronic device includes a carrier, a waveguide structure, and an antenna structure. The waveguide structure is supported by the carrier. A rigidity of the waveguide structure is greater than a rigidity of the carrier. The antenna structure is supported by the waveguide structure. The antenna structure includes an electromagnetic radiation circuit and a control circuit configured to control a radiating direction of an electromagnetic wave radiated from the electromagnetic radiation circuit.

### BACKGROUND

### 1. Field of the Disclosure

The present disclosure generally relates to an electronic device, specifically an electronic device that includes a waveguide structure separated from the carrier.

### 2. Description of the Related Art

To reduce the size electronic device packages and achieve higher integration density, several packaging solutions have been developed and implemented, including antenna in package (AiP), antenna on package (AoP), and substrate-integrated waveguide (SIW) antennas.

However, to support the industry's demand for increased functionality, the size of electronic device packages will inevitably increase, which may limit some applications (e.g., in portable devices).

### SUMMARY

In some arrangements, an electronic device includes a carrier, a waveguide structure, and an antenna structure. The waveguide structure is supported by the carrier. A rigidity of the waveguide structure is greater than a rigidity of the carrier. The antenna structure is supported by the waveguide structure. The antenna structure includes an electromagnetic radiation circuit and a control circuit configured to control a radiating direction of an electromagnetic wave radiated from the electromagnetic radiation circuit.

In some arrangements, an electronic device includes a carrier, a waveguide structure, an antenna structure, and a direction modifier. The carrier has a first dielectric constant. The waveguide structure has a second dielectric constant different from the first dielectric constant. The antenna structure is coupled to the carrier through the waveguide structure. The direction modifier is configured to adjust a coverage angle of an electromagnetic wave radiated from the antenna structure.

In some arrangements, an electronic device includes a radiation frequency (RF) circuit module and an antenna module. The antenna module is attached to the RF circuit module. The antenna module includes an antenna array and a plurality of components over the antenna array. The plurality of components is adjustable to control a radiating direction of an electromagnetic wave radiated from the antenna array.

### BRIEF DESCRIPTION OF THE DRAWINGS

Aspects of some arrangements of the present disclosure are best understood from the following detailed description when read with the accompanying figures. It is noted that various structures may not be drawn to scale, and dimensions of the various structures may be arbitrarily increased or reduced for clarity of discussion.

FIG. 1A is a cross-sectional view of an electronic device, in accordance with an arrangement of the present disclosure.

FIG. 1B illustrates a partial enlarged view of the electronic device as shown in FIG. 1A, in accordance with an arrangement of the present disclosure.

FIG. 1C illustrates a partial enlarged view of the electronic device as shown in FIG. 1A, in accordance with an arrangement of the present disclosure.

FIG. 1D illustrates a partial enlarged view of the electronic device as shown in FIG. 1A, in accordance with an arrangement of the present disclosure.

FIG. 2 is a schematic view of a layout of the waveguide structure and the slots of an electronic device, in accordance with an arrangement of the present disclosure.

FIG. 3 is a schematic view of a layout of the waveguide structure and the slots of an electronic device, in accordance with an arrangement of the present disclosure.

FIG. 4 is a partial layout of an electronic device, in accordance with an arrangement of the present disclosure.

FIG. 5 is a cross-sectional view of an electronic device, in accordance with an arrangement of the present disclosure.

FIG. 6 is a cross-sectional view of an electronic device, in accordance with an arrangement of the present disclosure.

FIG. 7 is a cross-sectional view of an electronic device, in accordance with an arrangement of the present disclosure.

FIG. 8 is a partial layout of an electronic device, in accordance with an arrangement of the present disclosure.

FIG. 9 is a schematic view illustrating electromagnetic waves of an electronic device, in accordance with an arrangement of the present disclosure.

Common reference numerals are used throughout the drawings and the detailed description to indicate the same or similar components. The present disclosure will be more apparent from the following detailed description taken in conjunction with the accompanying drawings.

### DETAILED DESCRIPTION

The following disclosure provides many different arrangements, or examples, for implementing different features of the provided subject matter. Specific examples of components and arrangements are described as follows. These are, of course, merely examples and are not intended to be limiting. In the present disclosure, reference to the formation or disposal of a first feature over or on a second feature in the description that follows may include arrangements in which the first and second features are formed or disposed in direct contact, and may also include arrangements in which one or more additional features may be formed or disposed between the first and second features, such that the first and second features may not be in direct contact. In addition, the present disclosure may repeat reference numerals and/or letters in the various examples. The same reference numerals and/or letters refer to the same or similar parts. This repetition is for the purpose of simplicity and clarity and does not in itself dictate a relationship between the various arrangements and/or configurations.

Arrangements of the present disclosure are discussed in detail as follows. It should be appreciated, however, that the present disclosure provides many applicable concepts that can be embodied in a wide variety of specific contexts. The specific arrangements discussed are merely illustrative and do not limit the scope of the disclosure.

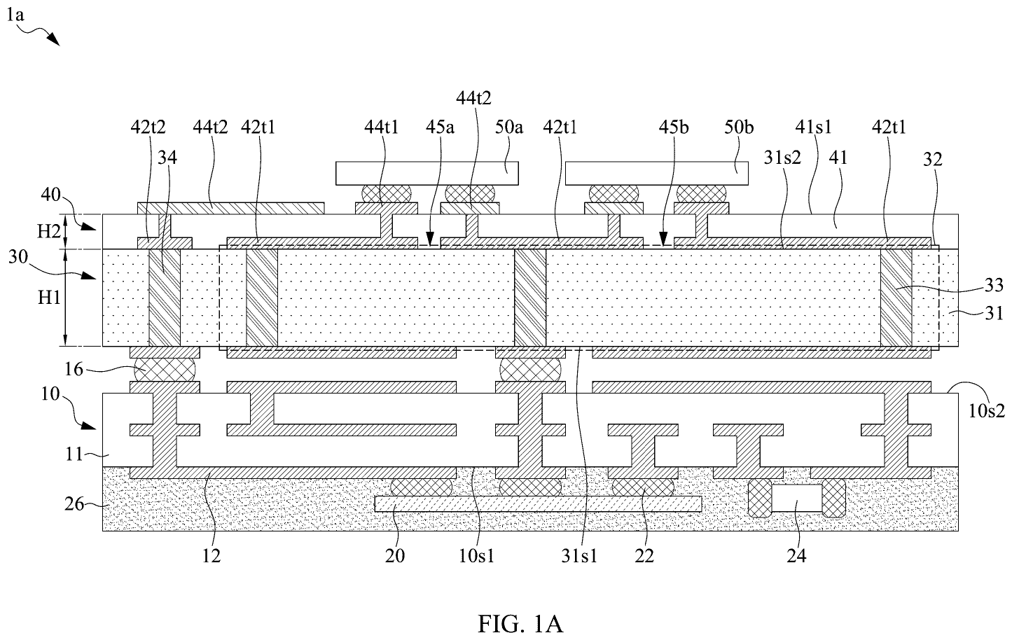

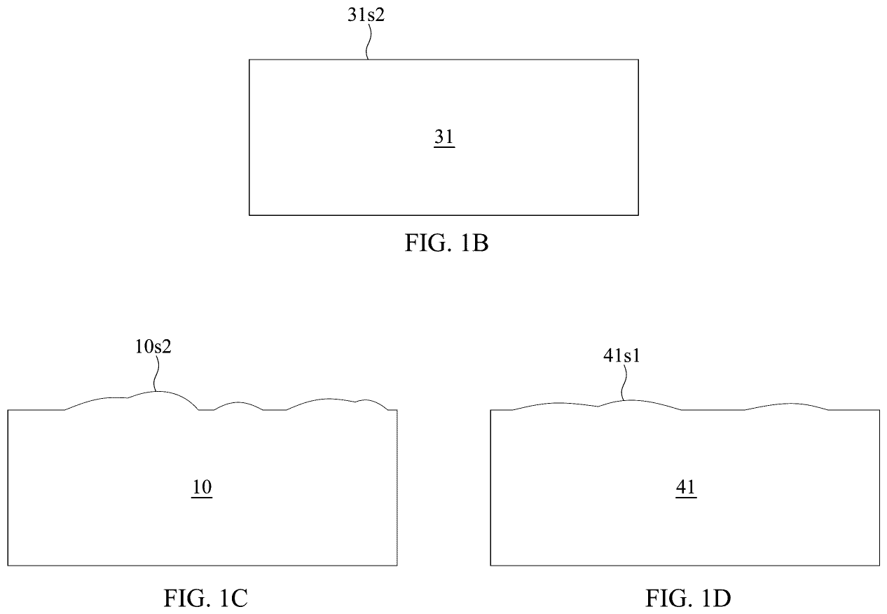

FIG. 1A is a cross-sectional view of an electronic device 1a, in accordance with an arrangement of the present disclosure. In some arrangements, the electronic device 1a may be applicable to, for example, a wireless device, such as user equipment (UE), a mobile station, a mobile device, an apparatus communicating with the Internet of Things (IoT), etc. In some arrangements, the electronic device 1a may be or include a portable device. In some arrangements, the electronic device 1a may support fifth generation (5G) communications, such as sub-6 GHz frequency bands and/or millimeter (mm) wave frequency bands. For example, the electronic device 1a may incorporate both sub-6 GHz devices and mm wave devices. In some arrangements, the electronic device 1a may support beyond-5G or 6G communications, such as terahertz (THz) frequency. The electronic device 1a may be configured to radiate and/or receive electromagnetic signals, such as radio frequency (RF) signals. For example, the electronic device 1a may be configured to operate in a frequency between about 10 GHz and about 10 THz, such as 10 GHz, 20 GHz, 30 GHz, 40 GHz, 50 GHz, 100 GHz, 300 GHz, 1 THz, 5 THz, or 10 THz.

In some arrangements, the electronic device 1a may include a carrier 10, an electronic component 20, a waveguide structure 30, an antenna structure 40, as well as switch elements 50a and 50b.

In some arrangements, the carrier 10 may include, for example, a printed circuit board (PCB), such as a paper-based copper foil laminate, a composite copper foil laminate, or a polymer-impregnated glass-fiber-based copper foil laminate. The carrier 10 may have a surface 10s1 (or a lower surface) and a surface 10s2 (or an upper surface) opposite to the surface 10s1. In some arrangements, the carrier 10 may include a dielectric structure 11 and a redistribution structure 12. The carrier 10 may further include one or more transmission lines (e.g., communications cables) and one or more grounding lines and/or grounding planes in proximity to, adjacent to, or embedded in and exposed at the surface 10s1 and/or surface 10s2 of the carrier 10.

In some arrangements, the dielectric structure 11 may include a plurality of dielectric layers. In some arrangements, the material of the dielectric structure 11 may include, for example, polypropylene (PP), polyimide (PI), or other suitable materials. In some arrangements, the lower surface of the dielectric structure 11 may be defined as the surface 10s1 of the dielectric structure 11. In some arrangements, the upper surface of the dielectric structure 11 may be defined as the surface 10s2 of the dielectric structure 11.

In some arrangements, the electronic device 1a may include a redistribution structure 12. The redistribution structure 12 may include a conductive pad(s), trace(s), via(s), layer(s), or other interconnection(s) embedded within the dielectric structure 11. In some arrangements, the redistribution structure 12 may be configured to provide the waveguide structure 30 with a feed signal. In some arrangements, the redistribution structure 12 may be configured to provide the antenna structure 40 with a feed signal. In some arrangements, the redistribution structure 12 may be configured to provide the antenna structure 40 with a feed signal through the waveguide structure 30. In some arrangements, the redistribution structure 12 may be configured to provide the antenna structure 40 with a control signal, which is configured to turn on or turn off the switch elements 50a and 50b. In some arrangements, a portion of the redistribution structure 12 may be electrically connected to the ground.

In some arrangements, the carrier 10 may be electrically coupled to the waveguide structure 30 through electrical connectors 16. In some arrangements, the electrical connector 16 may include, for example, a solder material, such as alloys of gold and tin solder or alloys of silver and tin solder. In some arrangements, the electrical connector 16 may be replaced by a hybrid-bond structure. In some arrangements, the electrical connector 16 may be exposed to air. In some arrangements, the electrical connector 16 may be encapsulated or covered by a dielectric layer, an underfill, or other suitable materials.

In some arrangements, the electronic component 20 may be disposed on or under the surface 10s1 of the carrier 10. The electronic component 20 may be adjacent to or disposed over the surface 10s1 of the carrier 10. The electronic component 20 may be electrically connected to one or more other electrical components (if any) and to the carrier 10 (e.g., to the interconnection(s)), and the electrical connection may be attained by way of flip-chip, wire-bond techniques, metal to metal bonding (such as Cu to Cu bonding), or hybrid bonding. The electronic component 20 may be a chip or a die including a semiconductor substrate, one or more integrated circuit (IC) devices and one or more overlying interconnection structures therein. The IC devices may include active devices such as transistors and/or passive devices such as resistors, capacitors, inductors, or a combination thereof. For example, the electronic component 20 may include a system on chip (SoC). For example, the electronic component 20 may include a radio frequency integrated circuit (RFIC), an application-specific IC (ASIC), a central processing unit (CPU), a microprocessor unit (MPU), a graphics processing unit (GPU), a microcontroller unit (MCU), a field-programmable gate array (FPGA), or another type of IC. In some arrangements, the electronic component 20 may be configured to provide the waveguide structure 30 with a signal (e.g., a feed signal). In some arrangements, the electronic component 20 may be configured to drive the slots of the antenna structure 40 operating in the On or Off mode.

In some arrangements, the electronic component 20 may be electrically coupled to the carrier 10 through electrical connectors 22. In some arrangements, the electrical connector 22 may include, for example, a solder material, such as alloys of gold and tin solder or alloys of silver and tin solder.

In some arrangements, the electronic device 1a may include a passive component 24. In some arrangements, the passive component 24 may be disposed on or under the surface 10s1 of the carrier 10. In some arrangements, the passive component 24 may include a capacitor, resistor, inductor, or a combination thereof.

In some arrangements, the electronic device 1a may include an encapsulant 26. In some arrangements, the encapsulant 26 may be disposed on or under the surface 10s1 of the carrier 10. The encapsulant 26 may encapsulate the electronic component 20. The encapsulant 26 may encapsulate the passive component 24. The encapsulant 26 may encapsulate the electrical connectors 22. The encapsulant 26 may include an insulation or dielectric material. In some arrangements, the encapsulant 26 may be made of molding material that may include, for example, a novolac-based resin, an epoxy-based resin, a silicone-based resin, or another suitable encapsulant. Suitable fillers may also be included, such as powdered SiO₂.

In some arrangements, the waveguide structure 30 may be disposed on or over the surface 10s2 of the carrier 10. In some arrangements, the waveguide structure 30 may be configured to provide the antenna structure 40 with a feed signal. In some arrangements, the waveguide structure 30 may include a substrate 31 and waveguide 32.

In some arrangements, the substrate 31 has a greater modulus (or rigidity) than the dielectric structure 11 has. In some arrangements, the substrate 31 has a greater dielectric constant than the dielectric structure 11 has. In some arrangements, the dielectric constant of the substrate 31 may range between about 4 and 7, such as 4, 5, 6, or 7. In some arrangements, the dielectric constant of the dielectric structure 11 may range between about 2 and 4, such as 2, 3, or 4. The greater dielectric constant of the substrate 31 may help to reduce the surface area (or volume) of the waveguide 32. In some arrangements, the waveguide structure 30 may include glass, ceramic, sapphire, or other suitable materials. In some arrangements, the material of the substrate 31 may be different from that of the dielectric structure 11. In some arrangements, the substrate 31 may be spaced apart from the dielectric structure 11 by the electrical connector 16. In some arrangements, the substrate 31 may be formed on the carrier 10 by a solder-bonding technique, which may include a reflow technique and other suitable techniques. In some arrangements, the substrate 31 may have a surface 31s1 (or lower surface) and a surface 31s2 (or upper surface) opposite to the surface 31s1. In some arrangements, a portion of the surface 31s1 may be exposed to air. In some arrangements, the lower surface of the substrate 31 may be defined as the surface 31s1 of the waveguide structure 30. In some arrangements, the upper surface of the substrate 31 may be defined as the surface 31s2 of the waveguide structure 30.

In some arrangements, the waveguide 32 may be defined by multiple conductive vias 33. In some arrangements, the conductive vias 33 may be embedded within the substrate 31. In some arrangements, the waveguide structure 30 may be configured to radiate an electromagnetic wave, such as an RF signal. In some arrangements, the waveguide structure 30 may define an electromagnetic resonator as the framed region shown in FIG. 1A. In some arrangements, the waveguide structure 30 may include or be made of a conductive structure, such as copper (Cu), tungsten (W), ruthenium (Ru), iridium (Ir), nickel (Ni), osmium (Os), ruthenium (Rh), aluminum (Al), molybdenum (Mo), cobalt (Co), alloys thereof, combinations thereof or any metallic materials.

The electronic device 1a may include conductive vias 34. In some arrangements, the conductive vias 34 may be embedded within the substrate 31. In some arrangements, the conductive vias 34 may be outside the waveguide region (or electromagnetic resonator) of the waveguide structure 30. In some arrangements, the conductive vias 34 may be disposed at a peripheral region of the substrate 31. In some arrangements, the conductive vias 34 may be electrically coupled to the switch elements 50a and 50b. In some arrangements, the conductive vias 34 may be configured to turn on and/or turn off the switch elements 50a and 50b.

In some arrangements, the antenna structure 40 may be disposed on or over the surface 31s2 of the waveguide structure 30. In some arrangements, the antenna structure 40 may be in contact with the surface 31s2 of the waveguide structure 30. In some arrangements, the antenna structure 40 may include a dielectric layer 41, a conductive trace 42t1, and a conductive trace 42t2.

The dielectric layer 41 may be disposed on or over the substrate 31. In some arrangements, the material of the dielectric layer 41 may be different from that of the substrate 31. In some arrangements, the material of the dielectric layer 41 may include, for example, polypropylene (PP), polyimide (PI), or other suitable materials. In some arrangements, the thickness H2 of the dielectric layer 41 may be less than the thickness H1 of the substrate 31. In some arrangements, the ratio of the thickness H2 to thickness H1 may range from about 0.3 to about 0.7, such as 0.3, 0.4, 0.5, 0.6, or 0.7. In some arrangements, the dielectric constant of the dielectric layer 41 may range between about 2 and 4, such as 2, 3, or 4.

In some arrangements, the conductive trace 42t2 may be electrically coupled to the conductive vias 34. In some arrangements, the conductive trace 42t2 may be in contact with the surface 31s2 of the waveguide structure 30. In some arrangements, the conductive trace 42t1 may define an SIW antenna. The conductive trace 42t1 may be configured to define a slot waveguide antenna. In some arrangements, the conductive trace 42t1 may include a conductive pattern which includes slots 45a and 45b. The conductive trace 42t1 may function as an electromagnetic radiation circuit configured to emit or receive RF signals. The slots 45a and 45b may serve as a part of an electromagnetic resonator, which results in equivalent surface magnetic currents along or across the slots 45a and 45b. In some arrangements, a portion of the waveguide 32, the slot 45a, and the slot 45b may form an electromagnetic resonator. In some arrangements, the slot 45a may vertically overlap the switch element 50a. In some arrangements, the slot 45b may vertically overlap the switch element 50b.

The conductive trace 42t2 (or control circuit) may be embedded within the dielectric layer 41. In some arrangements, the conductive vias 34 may be configured to turn on and/or turn off the switch elements 50a and 50b. In some arrangements, the conductive trace 42t1 and conductive trace 42t2 may be referred to as the metal one layer (M1).

In some arrangements, the antenna structure 40 may include a conductive trace 44t1 and a conductive trace 44t2. The conductive trace 44t1 and conductive trace 44t2 may be disposed on or over a surface 41t1 (or upper surface) of the dielectric layer 41. The conductive trace 44t1 may be electrically coupled to the conductive trace 42t1. In some arrangements, the conductive trace 44t1 may be electrically coupled to a first terminal of the switch element 50a (or 50b), and the conductive trace 44t2 may be electrically coupled to a second terminal of the switch element 50a (or 50b). In some arrangements, the conductive trace 44t1 and conductive trace 44t2 may define slots over the slots 45a and 45b, respectively. In some arrangements, the conductive trace 44t1 and conductive trace 44t2 may be referred to as the metal two layer (M2).

In some arrangements, the waveguide structure 30 and the antenna structure 40 may be collectively referred to as a waveguide-antenna structure.

In some arrangements, the switch elements 50a and 50b may disposed on or over the antenna structure 40. In some arrangements, the switch elements 50a and 50b may be disposed across a corresponding one of the slots 45a and 45b. In some arrangements, the switch elements 50a and 50b may cover a corresponding one of the slots 45a and 45b. For example, a first terminal (not annotated) of the switch elements 50a and 50b may be disposed at a first side of one of the slots 45a and 45b, and a second terminal (not annotated) of the switch elements 50a and 50b may be disposed at a second side, which is opposite to the first side, of the one of the slots 45a and 45b. In some arrangements, the switch elements 50a and 50b may be configured to control, modify, and/or adjust an electromagnetic wave, including radiation pattern and/or frequency, radiated from the carrier 10. In some arrangements, the switch elements 50a and 50b may be configured to enable and/or disable the slot 45a (or 45b) to function as a part of an electromagnetic resonator. In some arrangements, the switch elements 50a and 50b may include a varactor, such as diode(s), a transistor(s), or other suitable switches. In some arrangements, the switch elements 50a and 50b may function as a frequency modifier. In some arrangements, the switch elements 50a and 50b may function as a direction modifier (or electromagnetic wave direction modifier) to control or adjust the coverage angle of an electromagnetic wave radiated from the antenna structure 40. In this arrangements, by turning on or turning off the switch elements 50a and 50b, the radiation direction of an electromagnetic wave may be controlled. For example, the coverage angle of the electromagnetic wave may be controlled, thereby controlling the range or area of a received or transmitted electromagnetic wave. In some arrangements, when two or more switch elements are disposed over a slot, the frequency of an electromagnetic wave may be modified by turning on or off each switch elements.

FIGS. 1B, 1C, and 1D illustrate partial enlarged views of the electronic device as shown in FIG. 1A, in accordance with an arrangement of the present disclosure.

As shown in FIG. 1B, the surface 31s2 of the substrate 31 may be relatively flat. As shown in FIG. 1C, the surface 10s2 of the carrier 10 may be relatively rough. As shown in FIG. 1D, the surface 41s1 of the dielectric layer 41 may be relatively rough. In some arrangements, the surface roughness of the surface 31s2 of the substrate 31 may be less than the surface roughness of the surface 10s2 of the carrier 10. In some arrangements, the surface roughness of the surface 31s2 of the substrate 31 may be less than the surface roughness of the surface 41s1 of the dielectric layer 41. Similarly, the surface roughness of the surface 31s1 of the substrate 31 may be less than the surface roughness of the surface 10s2 of the carrier 10. The surface roughness of the surface 31s1 of the substrate 31 may be less than the surface roughness of the surface 41s1 of the dielectric layer 41.

In some cases, the operating frequency of an antenna is sensitive to the pattern or profile of the trace, leading to potential deviation in operating frequency and gain if the antenna pattern is not flat. However, in this arrangement, the antenna pattern is formed on a relatively smooth surface (e.g., surface 31s2), resulting in improved antenna performance. Additionally, in a comparative example, the waveguide structure and feeding trace are formed by stacking multiple dielectric layers (e.g., PI or PP), leading to a process window being impacted by previously formed layers and causing low yield. In contrast, in this arrangement, the substrate (e.g., substrate 31) of the waveguide structure and the carrier are two separate parts, which effectively addresses the aforementioned issues.

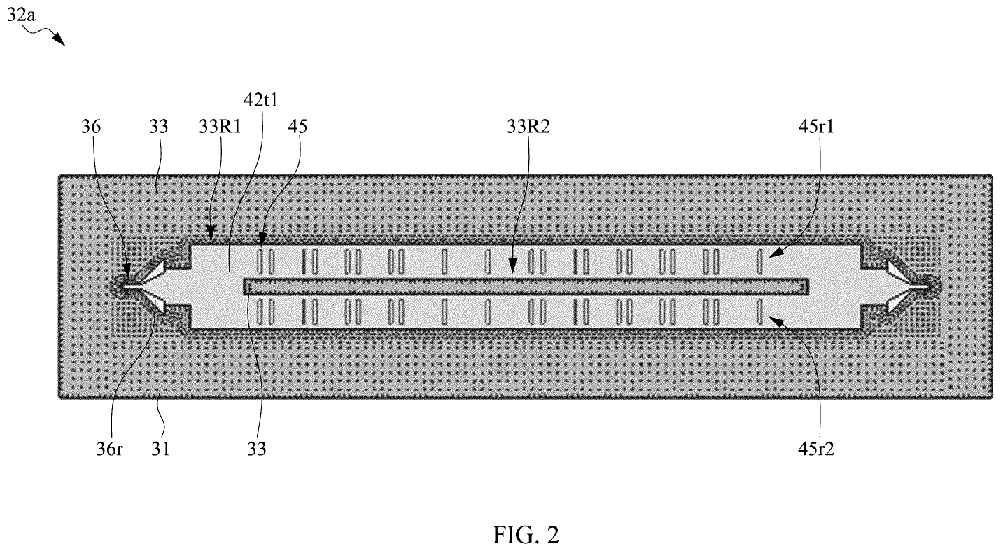

FIG. 2 is a schematic view of a layout of the waveguide 32a and slots 45 of an electronic device, in accordance with an arrangement of the present disclosure. The waveguide 32a and the slots 45 shown in FIG. 2 may be applicable to the electronic device 1a.

In some arrangements, the conductive vias 33 may include a region 33R1 (or ground via structure) and a region 33R2 (or ground via structure) separate from the region 33R1. The regions 33R1 and 33R2 may be regions on which ground vias are disposed. The conductive vias 33 may have different densities in different locations. In some arrangements, the conductive vias 33 may define an impedance-matching element 36. In some arrangements, the arrangement of the conductive vias 33 may have a tapered profile 36r to define the impedance-matching element 36. In some arrangements, the length of the tapered profile of the impedance-matching element 36 may range from about 0.25 times to about 0.5 times of the wavelength of a signal radiating from the waveguide. In some arrangements, the impedance-matching element 36 may be free from vertically overlapping the slots 45. In some arrangements, the density of the conductive vias 33 abutting the impedance-matching element 36 may be greater than that far from the impedance-matching element 36. In some arrangements, the density of the conductive vias 33 abutting the impedance-matching element 36 may be greater than that of the region 33R2.

In some arrangements, the conductive trace 42t1 may have openings to define the slots 45. In some arrangements, the slots 45 may have an array 45r1 and an array 45r2 spaced apart from the array 45r1 by the region 33R2 from a top view. In this arrangement, the region 33R2 is configured to define two waveguides (e.g., the first waveguide defined by the array 45r1 and the second waveguide defined by array 45r2).

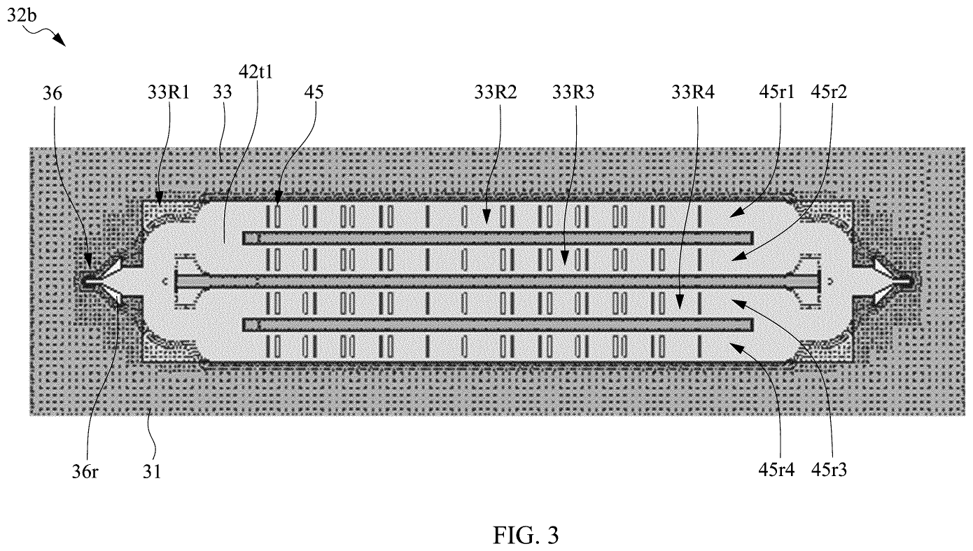

FIG. 3 is a schematic view of a layout of the waveguide 32b and slots 45 of an antenna of an electronic device, in accordance with an arrangement of the present disclosure. The waveguide 32b and the slots 45 shown in FIG. 3 may be applicable to the electronic device 1a.

In some arrangements, the waveguide 32b may further include a region 33R3 (or ground via structure) and a region 33R4 (or ground via structure). The regions 33R3 and 33R4 may be regions on which ground vias are disposed. The region 33R3 may be spaced apart from the region 33R2 by an array 45r2 from a top view. The region 33R4 may be spaced apart from the region 33R3 by an array 45r3 from a top view. The region 33R4 may be spaced apart from the region 33R1 by an array 45r4 from a top view. In some arrangements, the length, along the arrangement direction of the slots 45 of the array 45r1, of the region 33R3 may be different from that of the region 33R2 or the region 33R4. In this arrangement, the regions 33R2, 33R3, and 33R4 are configured to define four waveguides (e.g., the first waveguide defined by the array 45r1, the second waveguide defined by array 45r2, the third waveguide defined by the array 45r3, and the fourth waveguide defined by array 45r4).

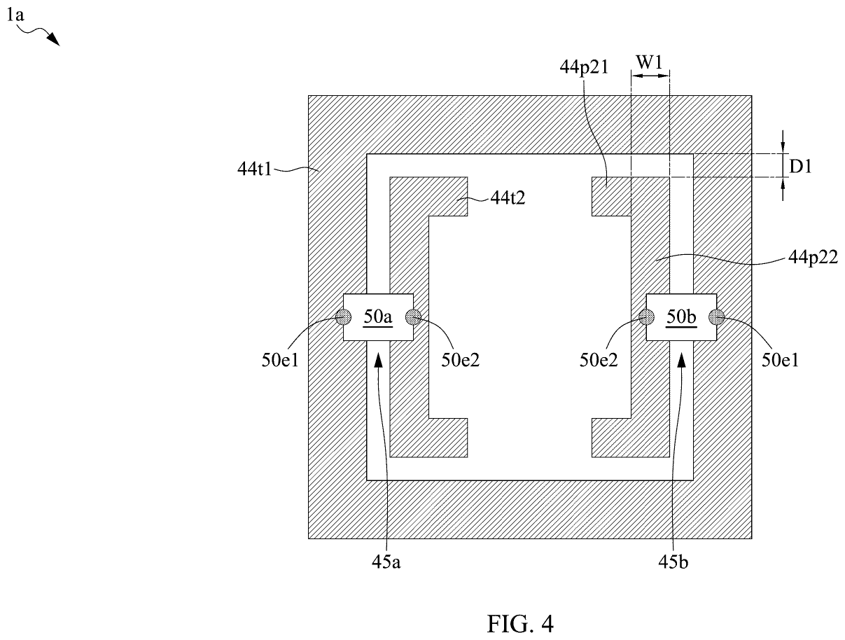

FIG. 4 is a partial layout of the M2 of the electronic device 1a, in accordance with an arrangement of the present disclosure.

The conductive trace 44t1 may surround the conductive trace 44t2. Although not shown in FIG. 4, it should be noted that the internal connection of the conductive traces 44t2 may be coupled by the M1 and the vias between the M1 and the M2. The gap between the conductive trace 44t1 and conductive trace 44t2 may define the slots 45a and 45b. In some arrangements, the switch element 50a or 50b may include a terminal 50e1 and a terminal 50e2. The terminal 50e1 may be electrically coupled to the conductive trace 44t1. The terminal 50e2 may be electrically coupled to the conductive trace 44t2. As a result, the conductive trace 44t2 may be configured to turn on or turn off the switch elements 50a and 50b to determine whether the slots 45a and 45b are in the On or Off mode. In some arrangements, the conductive trace 44t2 may be configured to control or modify a radiating direction(s) of an electromagnetic wave(s) radiated from the conductive trace 42t1. The conductive trace 44t2 may include parts 42p21 and parts 42p22. The part 44p22 may extend between the abutting parts 44p21. In some arrangements, the ratio of the width W1 of the part 44p22 to a distance D1 between the conductive trace 44t1 and part 44p22 may range between about 2 and about 5, such as 2, 3, 4, or 5.

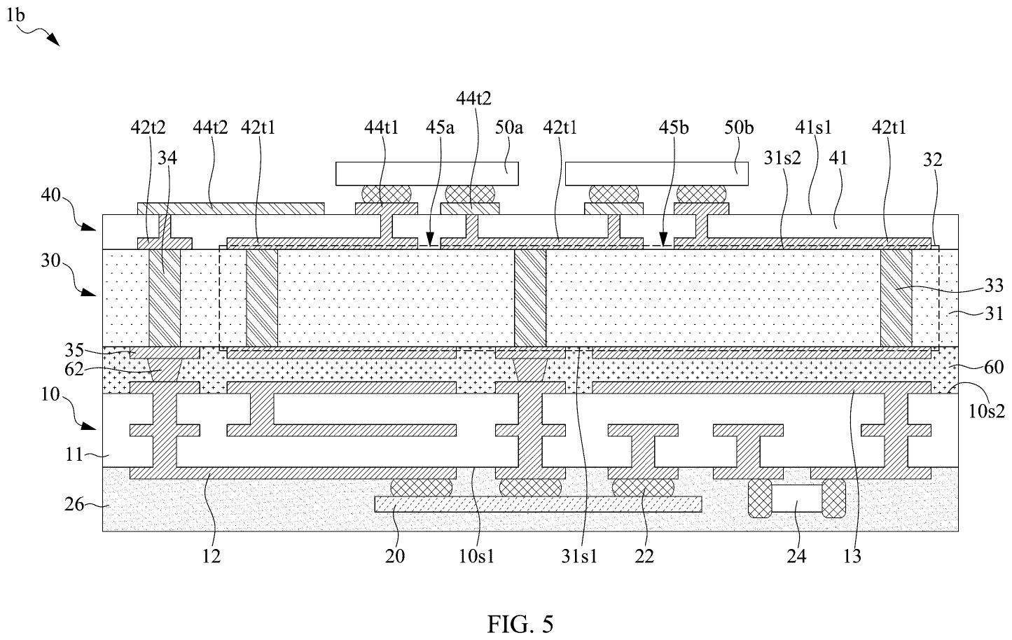

FIG. 5 is a cross-sectional view of an electronic device 1b, in accordance with an arrangement of the present disclosure. The electronic device 1b is similar to the electronic device 1a as shown in FIG. 1A, and the differences therebetween are described below.

In some arrangements, the electronic device 1b may include an adhesive layer 60 and a conductive structure 62 embedded within the adhesive layer 60. In some arrangements, the adhesive layer 60 may be disposed between the waveguide structure 30 and the carrier 10. The adhesive layer 60 may be configured to attach the waveguide structure 30 to the carrier 10. The adhesive layer 60 may function as a protection layer configured to protect the traces therein. The adhesive layer 60 may include epoxy, polyurethane, cyanoacrylate, acrylic polymers, or other suitable materials. The conductive structure 62 may be configured to electrically couple the carrier 10 to the waveguide structure 30. In some arrangements, the conductive structure 62 may be tapered toward the carrier 10. In some arrangements, the adhesive layer 60 may lose its viscosity in the final product and function as a connection layer.

The carrier 10 may include traces and/or pads 13 over the surface 10s2. The waveguide structure 30 may include traces and/or pads 35 under surface 31s1. The conductive structure 62 may extend and be coupled between the traces and/or pads 13 and the traces and/or pads 35. In some arrangements, the adhesive layer 60 may be formed on the carrier 10. The adhesive layer 60 may define openings to accommodate conductive pastes (e.g., copper pastes). Next, the traces and/or pads 35 may be pressed into the adhesive layer 60 and connected to the conductive pastes. Then, a curing technique may be performed to cure the adhesive layer 60 and the conductive pastes, forming the conductive structure 62.

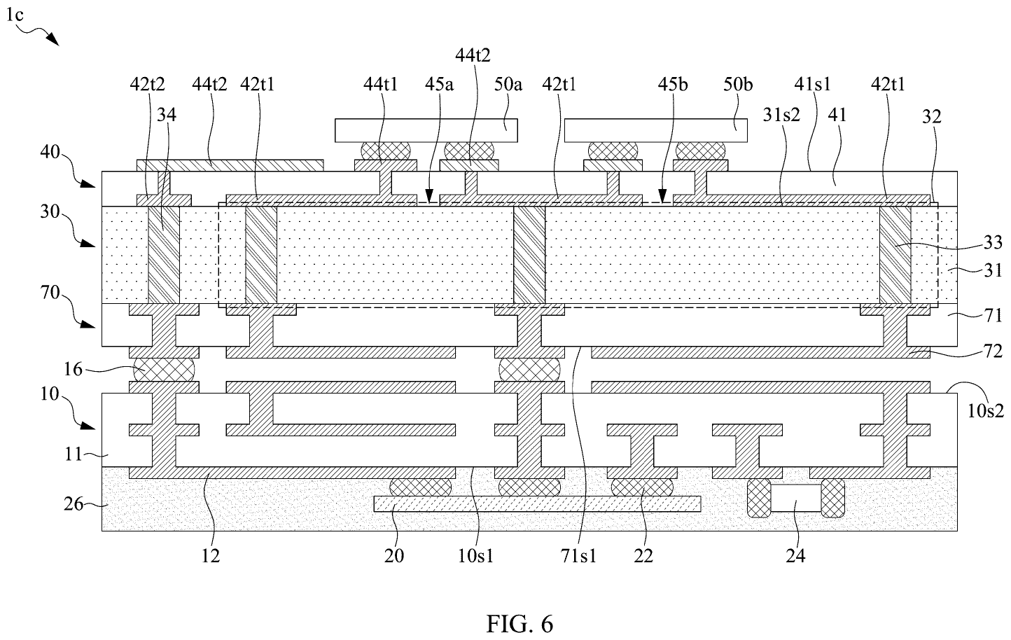

FIG. 6 is a cross-sectional view of an electronic device 1c, in accordance with an arrangement of the present disclosure. The electronic device 1c is similar to the electronic device 1a as shown in FIG. 1A, and the differences therebetween are described below.

In some arrangements, the electronic device 1c may include a circuit layer 70. The circuit layer 70 may be disposed on or under the surface 31s1 of the substrate 31. The circuit layer 70 may be electrically coupled to the electrical connector 16. The circuit layer 70 may include a dielectric layer 71 and a redistribution structure 72. In some arrangements, the material of the dielectric layer 71 may include, for example, polypropylene (PP), polyimide (PI), or other suitable materials. In some arrangements, a surface (or a lower surface) 71s1 of the dielectric layer 71 may be exposed to air.

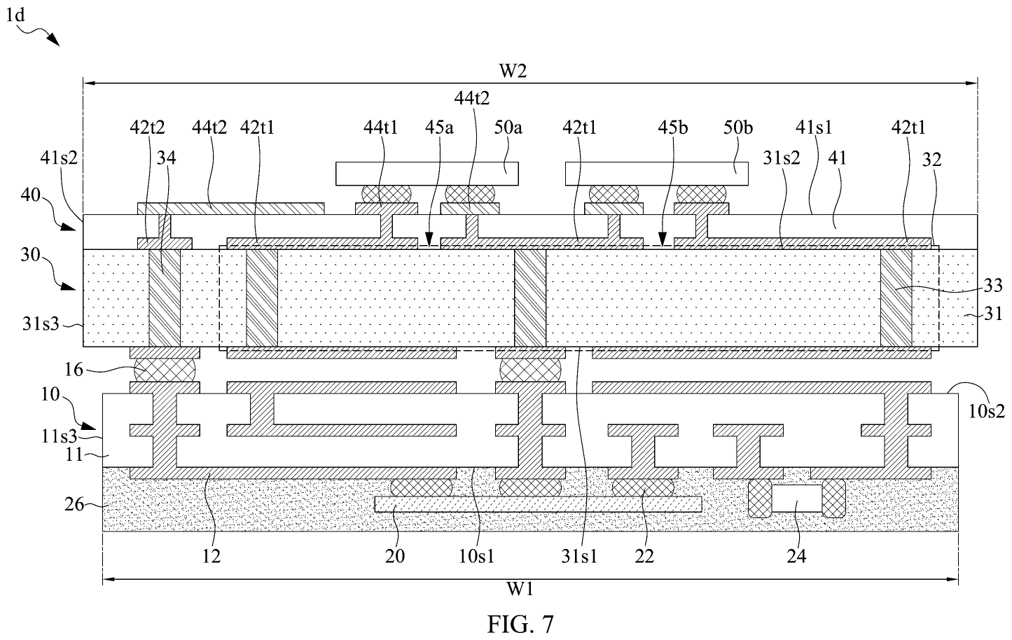

FIG. 7 is a cross-sectional view of an electronic device 1d, in accordance with an arrangement of the present disclosure. The electronic device 1d is similar to the electronic device 1a as shown in FIG. 1A, and the differences therebetween are described below.

In some arrangements, the width W1 of the carrier 10 may be different from the width W2 of the waveguide structure 30. In some arrangements, the width W2 of the waveguide structure 30 may be greater than the width W1 of the carrier 10. In this arrangement, the electronic device 1d has a control circuit (e.g., the conductive vias 34, the conductive trace 42t2, and the conductive trace 44t2), and the larger surface area of the surface 31s2 may facilitate the design of the antenna pattern.

In some arrangements, a surface 41s2 (or a lateral surface) of the dielectric layer 41 of the antenna structure 40 may be substantially aligned with a surface 31s3 (or a lateral surface) of the substrate 31 of the waveguide structure 30. In some arrangements, a surface 11s3 (or a lateral surface) of the dielectric structure 11 of the carrier 10 may be misaligned with the surface 31s3 of the substrate 31 of the waveguide structure 30.

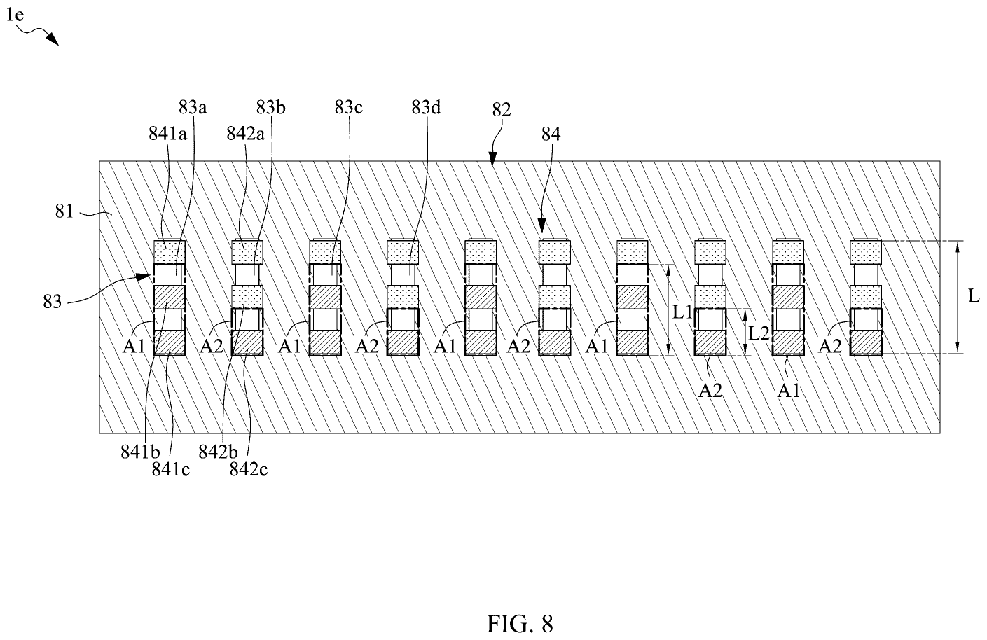

FIG. 8 is a partial layout of an electronic device 1e, in accordance with an arrangement of the present disclosure.

In some arrangements, the electronic device 1e may include a waveguide 81 and a circuit 82. The waveguide 81 and circuit 82 may define slots 83. The electronic device 1e may include switch elements 84 over slots 83. In some arrangements, the switch elements 84 may include switch elements 841a, 841b, 841c, 842a, 842b, and 842c. The slots 83 may include slots 83a, 83b, 83c, and 83d arranged along a horizontal direction. In some arrangements, the switch elements 841a, 841b, and 841c may be disposed across the slot 83a. In some arrangements, the switch elements 842a, 842b, and 842c may be disposed across the slot 83b. The electronic device 1e may include control circuits (not shown) configured to turn on or turn off each switch elements 84. In some arrangements, the layout shown in FIG. 8 may be applied to the M1 of the electronic device 1a.

In some arrangements, the switch elements 841a, 841b, and 841c may be configured to control, adjust, and/or modify the equivalent length of the slot 83a. In some arrangements, the switch elements 842a, 842b, and 842c may be configured to control, adjust, and/or modify the equivalent length of the slot 83b. In some arrangements, the equivalent length L of the slot along a vertical direction may depend on the operation of the switch elements. The frequency of the electromagnetic wave may be decreased by turning on the switch elements.

In some arrangements, the switch elements 84 may be configured to define apertures A1 and A2. The aperture A1 and/or A2 may be regarded as an imaginary region of an effective slot. In some arrangements, the geometric profile of the apertures A1 and A2 may be adjusted, controlled, or modified by the circuit 82. The geometric profile of the aperture A1 (or A2) may indicate an effective area, including effective length and effective width, of the slot 83. For example, when the switch element 841a is in the on condition, the waveguide 81 may define the aperture A1, which has an equivalent length L1. When the switch elements 842a and 842b are in the on condition, the waveguide 81 may define the aperture A2, which has an equivalent length L2. The apertures A1 may be aligned with the apertures A2 along the horizontal direction. The apertures A1 and A2 may have an array arrangement along the horizontal direction. The apertures A1 and A2 may are alternatively arranged so that one of the apertures A2 may be disposed between abutting two apertures A1. The apertures A1 may be configured to radiate electromagnetic waves which form a constructive interference at a first frequency. The apertures A2 may be configured to radiate electromagnetic waves which form a constructive interference at a second frequency different from the first frequency. The slots 83 defining the aperture A1 may be regarded as a group, and the slots 83 defining the aperture A2 may be regarded as another group. When a frequency of an electromagnetic wave from the waveguide 81 is determined, the condition (in and on condition) of the switch elements 84 may be determined so that the distribution of the equivalent length L of each slots 83 (or aperture) may be determined. As a result, the distribution of the apertures (e.g., A1 and A2) may be obtained, and the distance or pitch of the apertures, having the same equivalent length L, may be obtained. For example, when a specific frequency of an electromagnetic wave radiated from the waveguide 81 is determined, the distribution of the apertures A1 and A2 with different equivalent lengths L1 and L2 may be obtained. In this condition, the distance (or pitch) between two abutting apertures A1 (or A2) can be calculated based on the frequency of the electromagnetic wave. In other conditions, three or more different apertures (or groups) may be defined based on the frequency of the electromagnetic wave.

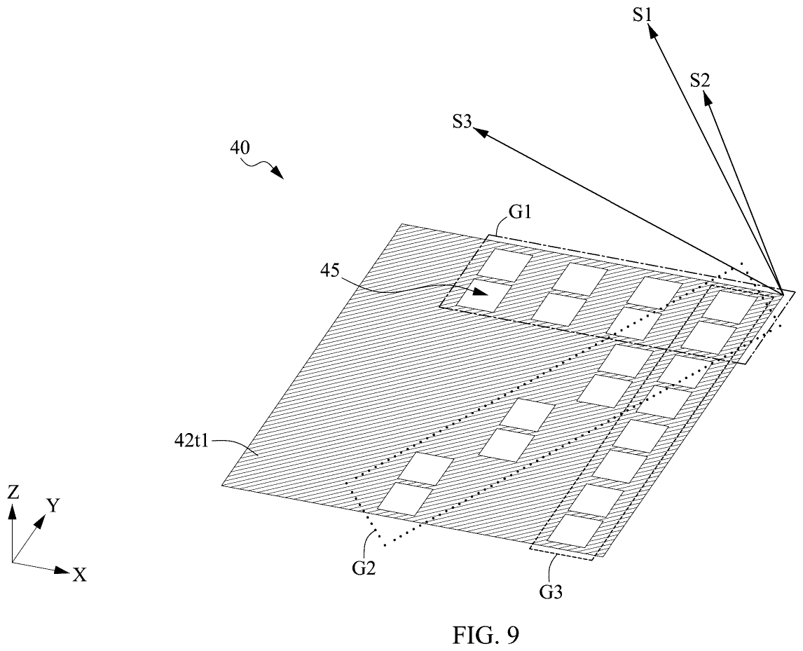

FIG. 9 is a schematic view illustrating electromagnetic waves of an electronic device 1F, in accordance with an arrangement of the present disclosure.

In some arrangements, the slots 45 may be classified into different groups which are arranged in different directions. For example, the slots 45 may be classified into groups G1, G2, and G3. Each of the groups G1, G2, and G3 may include a slot array arranged in different directions. The slots 45 of the group G1 may be arranged along the X direction. The slots 45 of the group G3 may be arranged along the Y direction. The slots 45 of the group G2 may be arranged along a direction slanted with respect to both the X direction and the Y direction. The arrangement direction of the slots 45 may determine the radiation direction of a signal (or electromagnetic wave) of the antenna structure 40. In this arrangement, the signals S1, S2, and S3 radiating from the groups G1, G2, and G3 may define a relatively large solid angle. In this arrangements, the coverage angle of an electromagnetic wave(s) may be adjusted.

Spatial descriptions, such as “above,” “below,” “up,” “left,” “right,” “down,” “top,” “bottom,” “vertical,” “horizontal,” “side,” “higher,” “lower,” “upper,” “over,” “under,” and so forth, are indicated with respect to the orientation shown in the figures unless otherwise specified. It should be understood that the spatial descriptions used herein are for purposes of illustration only and that practical implementations of the structures described herein can be spatially arranged in any orientation or manner, provided that the merits of arrangements of this disclosure are not deviated from by such an arrangement.

As used herein, the term “vertical” is used to refer to upward and downward directions, whereas the term “horizontal” refers to directions transverse to the vertical directions.

As used herein, the terms “approximately,” “substantially,” “substantial” and “about” are used to describe and account for small variations. When used in conjunction with an event or circumstance, the terms can refer to instances in which the event or circumstance occurs precisely as well as instances in which the event or circumstance occurs to a close approximation. For example, when used in conjunction with a numerical value, the terms can refer to a range of variation less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, a first numerical value can be deemed to be “substantially” the same or equal to a second numerical value if the first numerical value is within a range of variation of less than or equal to ±10% of the second numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” perpendicular can refer to a range of angular variation relative to 90° that is less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Two surfaces can be deemed to be coplanar or substantially coplanar if a displacement between the two surfaces is not exceeding 5 μm, not exceeding 2 μm, not exceeding 1 μm, or not exceeding 0.5 μm. A surface can be deemed to be substantially flat if a displacement between the highest point and the lowest point of the surface is not exceeding 5 μm, not exceeding 2 μm, not exceeding 1 μm, or not exceeding 0.5 μm.

As used herein, the singular terms “a,” “an,” and “the” may include plural referents unless the context clearly dictates otherwise.

As used herein, the terms “conductive,” “electrically conductive” and “electrical conductivity” refer to an ability to transport an electric current. Electrically conductive materials typically indicate those materials that exhibit little or no opposition to the flow of an electric current. One measure of electrical conductivity is Siemens per meter (S/m). Typically, an electrically conductive material is one having a conductivity exceeding approximately 10⁴ S/m, such as at least 10⁵ S/m or at least 10⁶ S/m. The electrical conductivity of a material can sometimes vary with temperature. Unless otherwise specified, the electrical conductivity of a material is measured at room temperature.

Additionally, amounts, ratios, and other numerical values are sometimes presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified.

While the present disclosure has been described and illustrated with reference to specific arrangements thereof, these descriptions and illustrations are not limiting. It should be understood by those skilled in the art that various changes may be made and equivalents may be substituted without departing from the true spirit and scope of the present disclosure as defined by the appended claims. The illustrations may not necessarily be drawn to scale. There may be distinctions between the artistic renditions in the present disclosure and the actual apparatus due to manufacturing processes and tolerances. There may be other arrangements of the present disclosure which are not specifically illustrated. The specification and drawings are to be regarded as illustrative rather than restrictive. Modifications may be made to adapt a particular situation, material, composition of matter, method, or process to the objective, spirit, and scope of the present disclosure. All such modifications are intended to be within the scope of the claims appended hereto. While the methods disclosed herein have been described with reference to particular operations performed in a particular order, it will be understood that these operations may be combined, sub-divided, or re-ordered to form an equivalent method without departing from the teachings of the present disclosure. Accordingly, unless specifically indicated herein, the order and grouping of the operations are not limitations of the present disclosure.

What is claimed is:

1. An electronic device, comprising:
a carrier;
a waveguide structure supported by the carrier, wherein a rigidity of the waveguide structure is greater than a rigidity of the carrier; and
an antenna structure supported by the waveguide structure and comprising:
an electromagnetic radiation circuit; and
a control circuit configured to control a radiating direction of an electromagnetic wave radiated from the electromagnetic radiation circuit.

2. The electronic device of claim 1, wherein the waveguide structure comprises a substrate and a plurality of vias embedded within the substrate.

3. The electronic device of claim 2, wherein the substrate comprises glass.

4. The electronic device of claim 2, wherein the antenna structure comprises a dielectric layer over the substrate of the waveguide structure, and the control circuit is disposed over the dielectric layer.

5. The electronic device of claim 2, wherein a roughness of an upper surface of the substrate is less than a roughness of an upper surface of the carrier.

6. The electronic device of claim 1, further comprising:
a varactor disposed over the antenna structure and coupled to the control circuit, wherein the electromagnetic radiation circuit defines a slot vertically overlapping the varactor.

7. The electronic device of claim 1, wherein a width of the carrier is different from a width of the waveguide structure.

8. The electronic device of claim 1, wherein a lateral surface of the carrier is misaligned with a lateral surface of the waveguide structure.

9. The electronic device of claim 8, wherein a lateral surface of the antenna structure is substantially aligned with the lateral surface of the waveguide structure.

10. The electronic device of claim 1, further comprising:
a protection layer disposed between the waveguide structure and the carrier.

11. An electronic device, comprising:
a carrier having a first dielectric constant;
a waveguide structure having a second dielectric constant different from the first dielectric constant;
an antenna structure coupled to the carrier through the waveguide structure; and
a direction modifier configured to adjust a coverage angle of an electromagnetic wave radiated from the antenna structure.

12. The electronic device of claim 11, wherein the antenna structure comprises a control circuit coupled to the direction modifier.

13. The electronic device of claim 12, wherein the waveguide structure comprises first vias defining a waveguide and second vias coupled between the control circuit of the antenna structure and the carrier.

14. The electronic device of claim 13, wherein the antenna structure comprises a first conductive layer coupled to a first terminal of the direction modifier and a second conductive layer coupled to a second terminal of the direction modifier.

15. The electronic device of claim 11, wherein the antenna structure comprises slot arrays.

16. The electronic device of claim 15, wherein the slot arrays comprise a first group configured to radiate a first electromagnetic wave along a first direction and a second group configured to radiate a second electromagnetic wave along a second direction different from the first direction.

17. The electronic device of claim 16, wherein the first group of the slot arrays are arranged non-parallel to the second group of the slot arrays.

18. An electronic device, comprising:
a radiation frequency (RF) circuit module; and
an antenna module attached to the RF circuit module and comprising an antenna array and a plurality of components over the antenna array;
wherein the plurality of components is adjustable to control a radiating direction of an electromagnetic wave radiated from the antenna array.

19. The electronic device of claim 18, wherein the antenna array comprises a first slot with a first equivalent length and a second slot with a second equivalent length different from the first equivalent length, and wherein frequencies of the electromagnetic wave from the antenna array depends on the first equivalent length and the second equivalent length.

20. The electronic device of claim 19, wherein the plurality of components comprises a first group over the first slot and a second group over the second slot.
